(19) United States
(12) Patent Application Publication
(10) Pub. No.: US 2008/0226854 A1
(43) Pub. Date: Sep. 18, 2008

(54) Metallized films

(76) Inventor: Yves M. Trouilhet, Vesenaz (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/077,307

(22) Filed: Mar. 17, 2008

Related U.S. Application Data
(60) Provisional application No. 60/918,153, filed on Mar. 15, 2007.

(51) Int. Cl. B32B 3/00; B32B 15/08; B32B 15/082; B32B 7/04

(52) U.S. Cl. 428/35.2; 428/461; 428/200; 428/172

(57) ABSTRACT

Provided herein are multilayer film structures that may be used in packaging applications, for example. The multilayer film structures include a first metallized thermoplastic film and a second thermoplastic film. These first and second films are joined directly to each other over at least a portion of their surface area to form a laminate having the structure “first thermoplastic film/metallic layer/second thermoplastic film”. The thermoplastic layers of the films may be the same or different and comprise one or more ethylene acid copolymers or ionomers thereof. The first metallized thermoplastic film has an optical density of 3 or less. When the first metallized thermoplastic film and the second thermoplastic film are joined by heat sealing to form the structure “thermoplastic film/metallic layer/thermoplastic film”, its internal seal strength is at least about 4 N/15 mm.

### CROSS-REFERENCE TO RELATED APPLICATION

The present application claims priority under 35 U.S.C. § 120 to U.S. Provisional Appln. No. 60/918,153, filed on Mar. 15, 2007, which is incorporated herein by reference in its entirety.

### BACKGROUND OF THE INVENTION

1. Field of the Invention

The present invention relates to multilayer film structures. More specifically, the present invention relates to multilayer film structures having an interior metallized layer and good internal adhesion to the metallized layer. These multilayer film structures may be used in packaging applications, for example.

2. Description of the Related Art

Several patents and publications are cited in this description in order to more fully describe the state of the art to which this invention pertains. The entire disclosure of each of these patents and publications is incorporated by reference herein.

Metallized polymer films are widely used in flexible packaging. They may fulfill one or more functions, such as decoration, light barrier or light reflector, gas barrier, heat insulation or electrical conductor. Conventional metallized films are typically based on bi-axially oriented polyethylene terephtalate (boPET) and bi-axially oriented polypropylene (boPP).

In general, however, it can be difficult to achieve good adhesion to a metallized surface. With the aim of improving this adhesion, French Patent No. 2850975 A1 describes a multilayer structure comprising a layer of boPP or boPET that is applied on a metallized film by means of a propylene-based binder co-grafted with unsaturated carboxylic acid. Further in this connection, Intl. Patent Appln. Publn. No. WO2003/072357 describes a multilayer oriented polyolefin film comprising a metallocene polypropylene (mPP) as a metallizable layer. In addition, European Patent No. 885919 B1 and U.S. Pat. No. 5,525,421 describe metallized films based on a polyester film or an oriented polypropylene layer and coated with polyvinyl alcohol. Last, Intl. Patent Appln. Publn. No. WO2000/024967 describes metallized substrates such as paper, card or board that are coated with an adhesive layer in the form of an aqueous ethylene acrylic copolymer dispersion.

These multilayer structures may suffer from poor adhesion between the metal and its substrate, however. This poor adhesion may lead to the deterioration of the multilayer structure or to its delamination after a relatively short time or under normal conditions of use.

In light of the above, there is a current need for multilayer film structures that include a metallized layer and that have excellent internal adhesion to the metal. There is a further need for multilayer film structures that include a metallized layer and that can be manufactured easily and economically. Still further, there is a need for multilayer film structures that include a metallized layer and that have excellent seal strength which persists for a relatively longer time, or under conditions of use ranging from normal to rigorous.

### SUMMARY OF THE INVENTION

Accordingly, described herein is a multilayer film structure comprising a first metallized thermoplastic film and a second thermoplastic film. These first and second films have a surface area. The first metallized thermoplastic film comprises a first thermoplastic film and a metallic layer that is coated directly onto at least a portion of the surface area of the first thermoplastic film. The first and second films are joined directly to each other over at least a portion of their surface area to form a laminate having the structure “first thermoplastic film/metallic layer/second thermoplastic film”.

The first and second thermoplastic films may be the same or different, and they independently comprise one or more ethylene acid copolymers or ionomers thereof. The ethylene acid copolymers consist essentially of copolymerized residues of ethylene, copolymerized residues of one or more α,β-unsaturated carboxylic acids having from 3 to 8 carbon atoms, and, optionally, copolymerized residues of one or more alkyl acrylates or alkyl methacrylates.

The metallic layer consists essentially of one or more metals and has an optical density of 3 or less.

Finally, when the first metallized thermoplastic film and the second thermoplastic film are joined by heating at a temperature of at least 90° C. and applying a pressure of 1.5 to 7 bar for a period of time of 0.5 to 4 seconds to form the “thermoplastic film/metallic layer/thermoplastic film” structure, the seal strength between the first metallized thermoplastic film and the second thermoplastic film is at least 4 N/15 mm.

Also provided is a pouch comprising the multilayer film structure.

### DETAILED DESCRIPTION OF THE INVENTION

The following definitions apply to the terms as used throughout this specification, unless otherwise limited in specific instances.

Moreover, unless otherwise defined, all technical and scientific terms used herein have the same meaning as commonly understood by one of ordinary skill in the art to which this invention belongs. In case of conflict, the present specification, including the definitions herein, will control.

Although methods and materials similar or equivalent to those described herein can be used in the practice or testing of the invention, suitable methods and materials are described herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise in limited circumstances. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

Moreover, where a range of numerical values is recited herein, unless otherwise stated in specific circumstances, the range is intended to include the endpoints thereof, and all integers and fractions within the range. It is not intended that the scope of the invention be limited to the specific values recited when defining a range. Finally, when the term “about” is used in describing a value or an end-point of a range, the disclosure should be understood to include the specific value or end-point referred to.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

As used herein, the terms “comprises,” “comprising,” “includes,” “including,” “containing,” “characterized by,” “has,” “having” or any other synonym or variation thereof refer to a non-exclusive inclusion. For example, a process, method, article, or apparatus that is described as comprising a particular list of elements is not necessarily limited to those particularly listed elements but may further include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’ format and fully open claims that are drafted in a ‘comprising’ format.”

Where an invention or a portion thereof is described with an open-ended term such as “comprising,” it is to be understood that, unless otherwise stated in specific circumstances, this description also includes a description of the invention using the terms “consisting essentially of” and “consisting of” as they are defined above.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

As used herein, the term “copolymer” refers to polymers comprising copolymerized units or residues resulting from copolymerization of two or more comonomers. In this connection, a copolymer may be described herein with reference to its constituent comonomers or to the amounts of its constituent comonomers, for example “a copolymer comprising ethylene and 9 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

The materials, methods, and examples herein are illustrative only and, except as specifically stated, are not intended to be limiting.

Finally, all percentages, parts, ratios, and the like set forth herein are by weight, unless otherwise stated in specific instances.

For many reasons, some of which are summarized above, metallized polymer films are widely used in flexible packaging. For example, certain metallized polymeric films have been developed with the aim of reducing heat leak and providing excellent insulating effects. Indeed, metallized surfaces have been used to minimize heat transfer by radiation. Moreover, metallized films can provide an impermeable barrier to gases such as oxygen and to moisture. This may be an important feature of packaging that is intended for food or for other sensitive products.

Suitable metallized films can be produced by conventional methods such as, for example, sputtering, electron beam heating, ion plating and direct vacuum metallization processes. In general, processes that are conducted under vacuum are preferred for use herein.

Particularly preferred is a vacuum metallization process in which a substrate, generally a polymeric layer, is introduced into a vacuum chamber, and vaporized metal is deposited onto the substrate's surface. Such a method may be carried out in a conventional metallizer, which typically consists of a chamber divided into two sections, both of which are evacuated to a pressure that is less than atmospheric pressure. In general, a vacuum between 10⁻² and 10⁻⁶ bar is used, preferably between 10⁻³ and 10⁻⁴ bar.

A reel or roll of substrate, that is, an unmetallized polymeric layer, is located in one of the two sections. The unmetallized substrate passes from the reel or roll into the other section, in which metal is vaporized and deposited onto a surface of the substrate. In general, the speed at which the substrate is carried through the metallization chamber is between about 1 and about 10 m/s, preferably at a speed between about 2 and about 6 m/s. In the metallization chamber, the substrate runs over a cooled cylinder that is maintained at a temperature between −5° C. and −35° C. After metallization, the metallized film usually passes back into the first section of the metallizer, where it is re-wound into a roll or reel.

The metallic layer is coated directly onto at least a portion of the surface area of the first thermoplastic film. Preferably, the metallic layer is coated directly onto the entire surface area of the first thermoplastic film.

Because the thickness of the metallic layer is typically very small, for example smaller than 1 micron, it may be difficult, inconvenient or uneconomical to measure directly. Specialized analytical techniques such as X-ray fluorescence or time-of-flight mass spectrometry may be required. For this reason, the amount or extent to which a substrate has been metallized is usually determined indirectly by measuring the optical density of the metallized substrate. The term “optical density”, as used herein, refers to the ratio of the intensity of light that is transmitted through a test specimen to the intensity of light that is incident upon the test specimen. Optical density is reported herein as the logarithm (base 10) of this ratio. For example, an optical density of 1 indicates that the intensity of the transmitted light is one tenth ( 1/10 or 0.1) of the intensity of the incident light, and a value of 2 indicates that the intensity of the transmitted light is one hundredth ( 1/100 or 0.01) of the intensity of the incident light.

The conditions under which optical density is measured (temperature, wavelength measured, e.g.) are typically determined by the requirements of the measuring apparatus. Most commercially available metallizers are equipped with an in-line device for measuring optical density.

Typical packaging applications require films having an optical density value of about 2.2; applications requiring a barrier to light or to gas call for films having an optical density value of about 2.4; and applications requiring a superior barrier to light, gas or heat call for films having an optical density value of at least about 2.6.

The multilayer film structure described herein comprises a metal layer coated directly onto a thermoplastic layer to produce a metallized thermoplastic film that has an optical density of about 3 or less, alternatively about 2.6 or less, about 2.4 or less, or about 2.2 or less. The metal layer may also be referred to herein by the synonymous and interchangeable terms “metallic layer” or “metallization layer”.

Preferably, the metallic layer comprises one or more metals chosen from the group consisting of aluminum, iron, copper, tin, nickel, silver, chromium and gold. Metallic layers comprising aluminum are preferred, and metallic layers consisting essentially of aluminum are more preferred.

The multilayer film structure described herein comprises a first metallized thermoplastic film and a second thermoplastic film. The first metallized thermoplastic film comprises a first thermoplastic film and a metallic layer that is coated directly onto at least a portion of the surface area of the first thermoplastic film. Preferably, the first thermoplastic film and the second thermoplastic film are self-supporting. In this respect, they are different from typical adhesive layers, which in general are not self-supporting. In this connection, the thickness of each of the thermoplastic film described herein is preferably between 3 and 100 μm.

The first metallized thermoplastic film and the second thermoplastic film are joined directly to each other over at least a portion of their surface area to form a laminate having the structure “first thermoplastic film/metallic layer/second thermoplastic film”. The term “joined directly to each other”, as used herein, refers to laminated layers that are adhered firmly together without the use of an intervening layer such as a tie layer or an adhesive layer. As is set forth in greater detail below, the magnitude of this “firm adhesion” is preferably 4N/15 mm or greater.

Desirably, the multilayer film structure described herein is highly resistant to deterioration or delamination over time or upon use. Preferably, a strong adhesive bond or seal strength between the thermoplastic films and the metallic layer is attained. As used herein, the term “seal strength” refers to the magnitude of the force per width of the thermoplastic film that is required to rupture a seal that is under tension. Accordingly, the seal strength is a measure of the ability of the multilayer structure described herein to resist the separation of its layers. Preferably, the multilayer film structure exhibits a seal strength that maintains this resistance over time. Stated alternatively, the seal strength is preferably constant for a period of at least about two weeks and more preferably about four weeks. The term “constant”, as used herein with respect to seal strength, refers to a later-measured value that is within about 10% of the value that is measured within about 24 hours after the heat seal is formed.

The multilayer structure described herein is considered to be adequately resistant to delamination when a force of 4 N or more must be applied to separate this structure over the width of the thermoplastic film of 15 mm. Moreover, the multilayer structure is considered to be adequately resistant to deterioration when its seal strength is constant for at least about two weeks or at least about four weeks. Preferably, the multilayer structure is adequately resistant to both delamination and deterioration. The seal strength may be measured by any means known in the art, and is preferably measured in a tensile tester such as the one available from Zwick Roell, AG, of Ulm, Germany at a pulling angle of 180° and at a head speed of 100 mm/min.

It has been found that the adhesion between the metallic layer and the thermoplastic films is sufficient and that the strength and durability of the multilayer film structure are also adequate when the first and second thermoplastic films comprise one or more independently selected ethylene acid copolymers or ionomers thereof. In particular, the first thermoplastic film that is the substrate of the first metallized thermoplastic film and the second thermoplastic film may have the same composition. Alternatively, they may have different compositions.

The ethylene acid copolymers comprise copolymerized residues of ethylene and of one or more α,β-ethylenically unsaturated carboxylic acids comprising from 3 to 8 carbon atoms. Acrylic acid and methacrylic acid are preferred acid comonomers. The ethylene acid copolymers may optionally contain a third, softening monomer. This “softening” monomer decreases the crystallinity of the ethylene acid copolymer. Suitable “softening” comonomers are selected from alkyl acrylates and alkyl methacrylates, wherein the alkyl groups have from 1 to 8 carbon atoms.

The ethylene acid copolymers can thus be described as E/X/Y copolymers, wherein E represents copolymerized units of ethylene, X represents copolymerized units of the α,β-ethylenically unsaturated carboxylic acid, and Y represents copolymerized units of the softening comonomer. The amount of X in the ethylene acid copolymer is from about 1 to about 20, preferably 9 to 20, more preferably 12 to 15 wt %, and the amount of Y is from 0 to about 30 wt %, preferably from 2 to 15 wt %, and more preferably 4 to 12 wt %, based on the total weight of the ethylene acid copolymer. The remainder of the copolymer comprises or consists essentially of copolymerized residues of ethylene.

Preferred are ethylene acid copolymers in which Y is 0% of the copolymer. That is, E/X dipolymers that consist essentially of copolymerized residues of ethylene and of one or more α,β-ethylenically unsaturated carboxylic acids comprising from 3 to 8 carbon atoms are preferred. Specific examples of these preferred ethylene acid copolymers include, without limitation, ethylene/acrylic acid and ethylene/methacrylic acid dipolymers.

In addition, the melt flow index of the suitable ethylene acid copolymers is between 10 to 30 decigrams/10 min, preferably from 20 to 30 decigrams/10 min, and more preferably from 23 to 28 decigrams/10 min, as measured by ASTM Method No. D1238 at 190° C. using a 2160 g weight.

Finally, methods of preparing ethylene acid copolymers are known. Ethylene acid copolymers with high levels of acid (X) can be prepared in continuous polymerizers by use of “co-solvent technology” as described in U.S. Pat. No. 5,028,674 or by employing somewhat higher pressures than those at which copolymers with lower acid can be prepared. In addition, ethylene acid copolymers suitable for use in the multilayer film structures described herein are commercially available under the trademark Nucrel® from E. I. du Pont de Nemours and Company of Wilmington, Del., U.S.A. (hereinafter “DuPont”).

The term “ionomers”, as used herein, refers to ethylene acid copolymers in which at least some of the carboxylic acid groups in the copolymer are neutralized to form the corresponding carboxylate salts. Suitable ionomers can be prepared from the ethylene acid copolymers described above.

More specifically, compounds suitable for neutralizing an ethylene acid copolymer include ionic compounds having basic anions and alkali metal cations (for example, lithium or sodium or potassium ions), transition metal cations (for example, zinc ion) or alkaline earth metal cations (for example magnesium or calcium ions) and mixtures or combinations of such cations. Ionic compounds that may be used for neutralizing the ethylene acid copolymers include alkali metal formates, acetates, nitrates, carbonates, hydrogen carbonates, oxides, hydroxides or alkoxides. Other useful ionic compounds include alkaline earth metal formates, acetates, nitrates, oxides, hydroxides or alkoxides of alkaline earth metals. Transition metal formates, acetates, nitrates, carbonates, hydrogen carbonates, oxides, hydroxides or alkoxides may also be used. Preferred neutralizing agents are sources of sodium ions, potassium ions, zinc ions, magnesium ions, lithium ions, transition metal ions, alkaline earth metal cations and combinations of two or more thereof.

In ionomers suitable for use in the multilayer film structures described herein, the acid moieties are neutralized to a level of from 1.0 to 99.9 equiv %, preferably from 20 to 75 equiv % and still more preferably from 20 to 40 equiv %. The amount of neutralizing agent(s) capable of deprotonating a targeted amount of acid moieties in the ethylene acid copolymer may be determined by simple stoichiometric calculation. Thus, in a relatively simply process, sufficient basic compound is made available so that, in aggregate, the desired level of neutralization can be achieved. The neutralization reaction may be carried out in any apparatus suitable for making a polymer blend, for example in an extruder.

In addition, the melt flow index of the suitable ionomers is between 1 to 15 decigrams/10 min, preferably from about 3 to 6 decigrams/10 min, as measured by ASTM Method No. D1238 at 190° C. using a 2160 g weight. Furthermore, suitable ionomers have a melting point between 80 and 110° C., preferably between 85 and 95° C., as measured by ASTM Method No. D3417.

Finally, suitable ionomers and methods of manufacturing ionomers are described further in U.S. Pat. No. 3,264,272, for example. Ionomers suitable for use in the multilayer film structures described herein are also commercially available from DuPont under the trademark Surlyn®.

The multilayer film structure described herein is formed by heat sealing. Specifically, the first metallized thermoplastic film and the second thermoplastic film are joined directly to each other over at least a portion of their surface area by heating at a temperature of at least 90° C. and applying a pressure of 1.5 to 7 bar for a period of time of 0.5 s to 4 s to form a laminate having the structure “first thermoplastic film/first metallic layer/second thermoplastic film”.

Preferably, the first and second thermoplastic films are heat sealable on themselves or on the first metallic layer. More preferably, the first and second thermoplastic films are heat sealable on themselves and on the first metallic layer. In particular, the term “second thermoplastic film” may refer to a portion of the first thermoplastic film of the first metallized thermoplastic film. The term “heat sealable”, as used herein, refers to a film that is capable of fusion bonding at a temperature equal to or greater than 90° C., under a pressure ranging between 1.5 and 7 bar that is applied for a period of time ranging between 0.5 s and 4 s. The term “heat sealable on itself”, as used herein, refers to a film that is capable of fusion bonding with another portion of itself, in a lap seal or in a transversal seal, by conventional heating means and without losing its structural integrity. Preferably, the first metallized thermoplastic film is heat sealable on itself at a temperature equal to or greater than 90° C., under a pressure ranging between 1.5 and 7 bar that is applied for a period of time ranging between 0.5 s and 4 s.

With the aim of further improving metal adhesion or of reducing the overall cost of the multilayer film structure, the ethylene acid copolymers or ionomers in the thermoplastic films can be partially replaced by one or more additional heat sealable polymers. The additional heat sealable polymers are preferably also cost effective, that is, a thermoplastic film formulated from a blend or combination of the ethylene acid copolymers or ionomers with the additional heat sealable polymers has a lower cost, with respect to the neat ethylene acid copolymers or ionomers, without a concomitant significant reduction of the multilayer film structure's heat seal performance properties, such as strength or durability.

Preferably, the one or more additional heat sealable polymers are chosen from the group consisting of polyethylene (PE), polypropylene, polyester, polyamide, ethylene vinyl acetate copolymer (EVA), ethylene methyl acrylate copolymer (EMA), ethylene butyl acrylate copolymer (EBA) and ethylene ethyl acrylate copolymer (EEA) and combinations or blends of two or more thereof. Various types of polyethylene polymers may be used, such as, for example, low density polyethylene, linear low density polyethylene, high density polyethylene or metallocene polyethylene.

The one or more additional heat sealable polymers may be present in an amount between 5 and 90 wt %, preferably 10 to 50 wt %, and more preferably 20 to 40 wt %, based on the total weight of the composition of the thermoplastic film.

The combination or blending may be effected by combining the one or more ethylene acid copolymers and/or ionomers thereof and the one or more additional heat sealable polymers by using any method known in the art, including, without limitation, melt mixing using an apparatus such as a single or twin-screw extruder, a blender, a kneader, a Haake mixer, a Brabender mixer, a Banbury mixer, a roll mixer, or the like. The combined or blended composition may subsequently be processed by means of any conventional technology such as extrusion, calendering, hot lamination, film casting or film blowing, to form a suitable thermoplastic film that may optionally serve as a metallization substrate.

Further provided herein is a multilayer film structure in which the first or the second thermoplastic film comprises three co-extruded layers. The first co-extruded layer is adjacent to the metallic layer (when present) and comprises one or more ethylene acid copolymers and/or ionomers thereof. The second co-extruded layer is adjacent to the first co-extruded layer and consists essentially of a heat sealable polymer chosen from the group consisting of polyethylene (PE), polypropylene, polyester, polyamide, ethylene vinyl acetate (EVA), ethylene methyl acrylate (EMA), ethylene butyl acrylate (EBA), ethylene ethyl acrylate (EEA) and combinations or blends of two or more thereof. The third co-extruded layer is adjacent to the second co-extruded layer and comprises one or more ethylene acid copolymers and/or ionomers thereof. The composition of the third co-extruded layer is independently selected and may be the same as or different from the composition of the first co-extruded layer. Preferably, the three co-extruded layers are adjoining, or, more preferably, contiguous. Stated alternatively, the three co-extruded layers are more preferably joined directly to each other.

Further provided herein is a sealed pouch comprising the first metallized film described above. In this pouch, the metallic layer faces the exterior of the pouch. The pouch is preferably sealed along its length in a lap seal, to reduce waste material in the seal. More specifically, in a lap seal two ends of the metallized film overlap, so that the thermoplastic film layer is sealed to the metallized layer of the same film. After filling the pouch with any suitable product, the pouch is further sealed across its width, preferably with two transverse seals. In the transverse seals, the thermoplastic film layer, which faces the packaged product in the interior of the pouch, is sealed on itself.

By using the materials and methods described herein, it is possible to achieve multilayer film structures having low seal initiation temperatures, which lead to increased line speeds, good hot tack strength, and strong, durable and reliable heat seals.

The invention is further described in the Examples below, which are provided to describe the invention in further detail. These examples, which set forth a preferred mode presently contemplated for carrying out the invention, are intended to illustrate and not to limit the invention.

### EXAMPLES

The following materials were used for preparing multilayer film structures:
Ionomer: a copolymer comprising ethylene and 15 wt % MAA (methacrylic acid), wherein 23% of the available carboxylic acid moieties are neutralized and the metal counterions are zinc(II) cations. This product is supplied by DuPont under the trademark Surlyn®.

### Example 1 (E1)

A 25 μm ionomer film was produced on a cast film line (Windmoeller & Hoelscher, Germany). The extruder temperatures were set for five extruder zones of the same length, according to a temperature profile of 160° C., 190° C., 220° C., 240° C. and 250° C. The temperatures of the die (2.4 m wide) and the connecting pipes were both set at 250° C. The temperature of the casting rolls were set at 20° C. The line speed was 100 m/min. Two rolls of film having a width of 1.1 m and a length of 4000 m were produced at the same time.

### Example 2 (E2)

The same film as Example 1 was produced and was corona treated on-line at a power of 10 kW before winding.

### Example 3 (E3)

A ionomer film was produced according to the method of Example 1. This film had a thickness of 17 μm.

The thermoplastic films E1, E2 and E3 were then metallized in a vacuum metallizer (Leybold, Germany) under a vacuum of 10⁻⁴ bar, at a speed of 4 m/s and at a cylinder temperature of −15° C. The metallized films had an optical density of 2.8. The films were then unwound and rewound under atmospheric pressure. The two 25 μm thick films (E1 and E2) were rewound at 100 m/min, and the 17 μm thick film (E1) was rewound at a maximum speed of 12 m/min to avoid rupture due to blocking.

For comparative purposes, the seal strength of the three following conventional metallized films was measured:

### Comparative Example 1 (C1)

a bi-axially oriented polyethylene terephthalate film supplied by DuPont Teijin Films, Japan under the tradename Melinex™ 800 that was metallized by Hoch-Vakuum-Beschichtungs GmbH, Berlin, Germany (thickness: 12 μm).

### Comparative Example 2 (C2)

a metallized bi-axially oriented polypropylene film supplied by Exxon Mobil Corporation, Buffalo, N.Y., USA, under the tradename Metallyte™ MM 488 (thickness: 18 μm).

### Comparative Example 3 (C3)

a metallized polyethylene film supplied by Pliant, USA (thickness: 25 μm).

The adhesion between the metallic layer and the polymeric substrate may be difficult to measure directly due to the small thickness of the metallic layer, on which it is not possible to apply a force as it is likely to break. In addition, the “tape adhesion” methods known to those of skill in the art do not always distinguish between the adhesive strengths of different metallized films, because it is often the case that the adhesion between the polymeric film and the metallized layer is stronger than the adhesion between the metallized layer and the adhesive of the tape. Thus, the adhesion was indirectly characterized by means of the seal strength of a thick structure sealed to the metallized films. With the aim of comparing the metal adhesion of samples E1, E2 and E3 with that of samples C1, C2 and C3, a structure of Al(35 μm)/ethylene acid copolymer(40 μm, Nucrel® 3990E) was sealed to the metallized surface of each of these six films. The sealing was done with a Sentinel heat sealer (Packaging industry, Massachusetts, USA, Model 12AS) under the following conditions: pressure 3 bar, temperature 160° C. and sealing time 2 seconds. The samples were stored under ambient conditions (23° C. and 30% RH) and their seal strength was measured 24 hours after sealing in a tensile tester (Zwick Roell, AG, Ulm, Germany) at a pulling angle of 180° and at 100 mm/min. In all cases, the seal failed at the interface between the thermoplastic film of samples C1, C2, C3, E1, E2 and E3 and the metallic layer. The seal strength data measured in this experiment are set forth in Table 1.

TABLE 1

| Sample | Seal Strength/N/15 mm |
|---|---|
| C1 | 2 to 3 |
| C2 | 0.6 |
| C3 | 1-1.4 |
| E1 | 5-6 |
| E2 | 5-6 |
| E3 | 4-5 |

The data set forth in Table 1 demonstrate that samples E1, E2 and E3 provide a stronger adhesion to metal than do the comparative samples C1, C2 and C3. In particular, a force of 5-6 N/15 mm is required to rupture the seals of the multilayer film structures formed from E1 and E2, and a force of 4-5 N/15 mm is required to rupture the seals of the multilayer film structure formed from sample E3. This corresponds to increase of up to a factor of two in seal strength in comparison with the multilayer film structures formed from samples C1, C2 and C3.

In addition, sample E1 was sealed on itself under the same sealing conditions described above to form a series of multilayer films having the structures “metallic layer/thermoplastic film/thermoplastic film/metallic layer”, “thermoplastic film/metallic layer/thermoplastic film/metallic layer” and “thermoplastic film/metallic layer/metallic layer/thermoplastic film”. The seal strengths were measured by the methods described above, and the results of this experiment are set forth in Table 2.

TABLE 2

| | Seal Strength |
|---|---|
| Sample E1 | N/15 mm |
| Sealing thermoplastic film to thermoplastic film | 7-8 |
| Sealing thermoplastic film to metallic layer | 5-5.5 |
| Sealing metallic layer to metallic layer | 0.8 |

The data in Table 2 demonstrate that the thermoplastic film of sample E1 is heat sealable both to itself and to the metallic layer of the sample. Moreover, the seal strength of the thermoplastic film of sample E1 to the metallic layer of the sample was measured four weeks after the seal was formed, yielding a value of 4.5 to 5.0 N/15 mm.

Without wishing to be held to theory, it is generally believed that the good adhesion between ionomers and metal foils or metallized films is due to a chemical reaction that forms covalent bonds between the non-neutralized acid groups of the ionomer and the surface hydroxyl groups of the oxidized metal layer. The oxidized metal layer forms on the surfaces of the metal foil or the metallized film that are contacted with oxygen or water, for example as a result of exposure to ambient atmospheric conditions. It is hypothesized that the oxidation of the metallic layer does not take place to any significant extent in a metallizer under high vacuum, however, due to the low availability of oxygen and water as reagents. It is therefore surprising that adhesion of the metallized layer to its ionomer substrate is relatively strong. It is further noted in this connection that the corona treatment of the thermoplastic film in sample E2 does not lead to any further improvement of the metal adhesion.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A multilayer film structure comprising a first metallized thermoplastic film and a second thermoplastic film, said first and said second films having a surface area, said first metallized thermoplastic film comprising a first thermoplastic film and a metallic layer coated directly onto at least a portion of the surface area of said first thermoplastic film, and said first and said second films joined directly to each other over at least a portion of their surface area to form a laminate having the structure “first thermoplastic film/metallic layer/second thermoplastic film”;
wherein the first and second thermoplastic films may be the same or different and independently comprise one or more ethylene acid copolymers or ionomers thereof, said one or more ethylene acid copolymers consisting essentially of copolymerized residues of ethylene, copolymerized residues of one or more α,β-unsaturated carboxylic acids having from 3 to 8 carbon atoms, and, optionally, copolymerized residues of one or more alkyl acrylates or alkyl methacrylates wherein the alkyl groups comprise from one to eight carbon atoms;
wherein the metallic layer consists essentially of one or more metals and has an optical density of 3 or less; and
wherein, when the first metallized thermoplastic film and the second thermoplastic film are joined by heating at a temperature of at least 90° C. and applying a pressure of 1.5 to 7 bar for a period of time of 0.5 to 4 seconds to form the “thermoplastic film/metallic layer/thermoplastic film” structure, the seal strength between the first metallized thermoplastic film and the second thermoplastic film is at least 4 N/15 mm.

2. The multilayer structure according to claim 1, wherein the seal strength measured within 24 hours after the seal is formed is within 10% of the seal strength measured at least two weeks after the seal is formed.

3. The multilayer structure according to claim 1, wherein the seal strength measured within 24 hours after the seal is formed is within 10% of the seal strength measured at least four weeks after the seal is formed.

4. The multilayer structure according to claim 1, wherein the one or more ethylene acid copolymers consist essentially of copolymerized residues of ethylene and copolymerized residues of acrylic acid or methacrylic acid.

5. The multilayer structure according to claim 1, wherein the one or more ionomers are obtained by neutralizing from 1.0 to 99.9% of the acid groups of the one or more ethylene acid copolymers and wherein the counterions comprise cations of sodium, potassium, zinc, magnesium, lithium or combinations of two or more of sodium, potassium, zinc, magnesium and lithium.

6. The multilayer structure according to claim 5, wherein the ionomers are obtained by neutralizing from 20 to 75% of the acid groups.

7. The multilayer structure according to claim 1, wherein the total amount of copolymerized residues of α,β-unsaturated carboxylic acids ranges from 1 to 20 wt % of the total weight of the one or more ethylene acid copolymers.

8. The multilayer structure according to claim 7, wherein the total amount of copolymerized residues of α,β-unsaturated carboxylic acids ranges from 9 to 20 wt % of the total weight of the one or more ethylene acid copolymers.

9. The multilayer structure according to claim 1, wherein the first or the second thermoplastic film comprises one or more additional heat sealable polymers.

10. The multilayer structure according to claim 9, wherein one of the first and the second thermoplastic film comprises from 5 to 90 wt % of one or more additional heat sealable polymers; or wherein each of the first and the first and the second thermoplastic film independently comprises from 5 to 90 wt % of one or more additional heat sealable polymers, wherein the one or more additional heat sealable polymers and the amounts of the one or more additional heat sealable polymers in the first and the second thermoplastic films may be the same or different; the weight percentage being based on the total weight of the thermoplastic film.

11. The multilayer structure according to claim 10, wherein the one or more additional heat sealable polymers are independently selected from the group consisting of polyethylene, polypropylene, polyester, polyamide, ethylene vinyl acetate copolymer (EVA), ethylene methyl acrylate copolymer (EMA), ethylene butyl acrylate copolymer (EBA), ethylene ethyl acrylate copolymer (EEA) and blends thereof.

12. The multilayer structure according to claim 1, wherein the metallic layer comprises one or more metals selected from the group consisting of aluminum, iron, copper, tin, nickel, silver, chromium and gold.

13. The multilayer structure according to claim 1, wherein the second thermoplastic film is a second metallized thermoplastic film comprising the second thermoplastic film and a second metallic layer that may be the same as or different from the first metallic layer coated directly onto said second thermoplastic film such that the laminate has the structure “first thermoplastic film/first metallic layer/second thermoplastic film/second metallic layer”.

14. The multilayer structure according to claim 1, wherein the first thermoplastic film or the second thermoplastic film comprises three co-extruded layers:
a. the first co-extruded layer being adjacent to the metallic layer and comprising one or more ethylene acid copolymers and/or ionomers thereof,
b. the second co-extruded layer being adjacent to the first co-extruded layer and consisting essentially of a heat sealable polymer chosen from the group consisting of polyethylene, polypropylene, polyester, polyamide, ethylene vinyl acetate (EVA), ethylene methyl acrylate (EMA), ethylene butyl acrylate (EBA), ethylene ethyl acrylate (EEA) and blends thereof; and
c. the third co-extruded layer, which may be the same as or different from the first co-extruded layer, being adjacent to the second co-extruded layer and comprising one or more ethylene acid copolymers and/or ionomers thereof.

15. The multilayer structure according to claim 1, wherein the first and the second thermoplastic films have thicknesses that may be the same or different and that are between 3 and 100 μm.

16. A sealed pouch comprising the multilayer structure of claim 1.

17. The sealed pouch according to claim 16, wherein the second thermoplastic film is a portion of the first thermoplastic film, and wherein the metallic layer faces the exterior of the pouch.

18. The sealed pouch according to claim 16, wherein the pouch is sealed along its length in a lap seal.

19. The sealed pouch according to claim 16, wherein said pouch contains any suitable product and is sealed across its width with one or more transverse seals.

20. The sealed pouch of claim 19, wherein the thermoplastic film faces the interior of the pouch and is sealed to itself in the transverse seals.
